(19) United States
(12) Patent Application Publication
(10) Pub. No.: US 2012/0091301 A1
(43) Pub. Date: Apr. 19, 2012

(54) MOUNTING SYSTEMS

(76) Inventor: FRANK MICHAEL BRAUN, Grundau (DE)

(21) Appl. No.: 12/905,429

(22) Filed: Oct. 15, 2010

(51) Int. Cl. F16B 39/22

(52) U.S. Cl. 248/231.91

(57) ABSTRACT

Drywall mounting systems for accessories are shown and described. In one example, In one example, a system includes an accessory adapter plate, a fixation plate, a drywall fastener, and a second fastener. The drywall fastener is used to secure the accessory adapter plate to the drywall. The fixation plate is then secured to the accessory adapter plate with the second fastener, which, inter alia, prevents the rotation of the AAP. Accessories can then be quickly and securely attached to the AAP.

### FIELD OF TECHNOLOGY

The current disclosure relates generally to mounting systems for accessories, and more particularly, to mounting systems for drywall.

### SUMMARY

Drywall, also intended herein to include gypsum board, wallboard, plasterboard, Gibraltar board, rock lath, rigips, regips, knauf, etc. and similar structures, is known in the art. A common drywall construction example includes a panel made of gypsum plaster pressed between sheets of paper. Drywall can be quickly hung to create walls and ceilings in buildings. Oftentimes, accessories will be attached to drywall. In the bathroom or kitchen, for example, accessories may include towel racks, trays, soap holders, mirrors, hand rails, etc.

Applicant believes traditional mounting systems may suffer from any variety of problems. For example, traditional mounting systems may require directional components, e.g., those that have a defined top and a bottom. Further, traditional mounting systems may require portions of the system to be mounted to the wall in a level positioning to insure proper interface with the accessory. Further, traditional mounting systems may attach to the wall at some distance off center from where the accessory is to be positioned, thereby requiring additional measurements to determine the appropriate offset needed. Further, traditional mounting systems may be weakly mounted to the wall and may pull out or damage the drywall if excessive force is applied.

Various examples of the current disclosure may be directed to at least one of these, or additional, problems.

### SUMMARY

The current disclosure is directed to a variety of mounting systems. In one example, a system includes an accessory adapter plate (AAP), a fixation plate (FP), a drywall fastener, and a second fastener. The drywall fastener is used to secure the AAP to the drywall. The FP is then secured to the AAP with the second fastener, which, inter alia, prevents the rotation of the AAP. Accessories can then be quickly and securely attached to the AAP.

The above summary was intended to summarize certain examples of the present disclosure. Systems, including additional embodiments, will be set forth in more detail in the figures and detailed description below. It will be apparent, however, that the detailed description is not intended to limit the present invention, the scope of which should be properly determined by the appended claims.

### BRIEF DESCRIPTION OF THE FIGURES

FIG. 1 illustrates a perspective view of a first embodiment of a mounting system according to the disclosure.

FIG. 2 illustrates a cut-away view of mounting system shown in FIG. 1.

FIG. 3 illustrates an accessory example.

FIG. 4 illustrates a perspective view of a second embodiment of a mounting system.

FIGS. 5 and 6 illustrate perspective views of a third embodiment of a mounting system.

FIG. 7 illustrates a perspective view of a fourth embodiment of a mounting system.

### DETAILED DESCRIPTION OF EXEMPLARY EMBODIMENTS

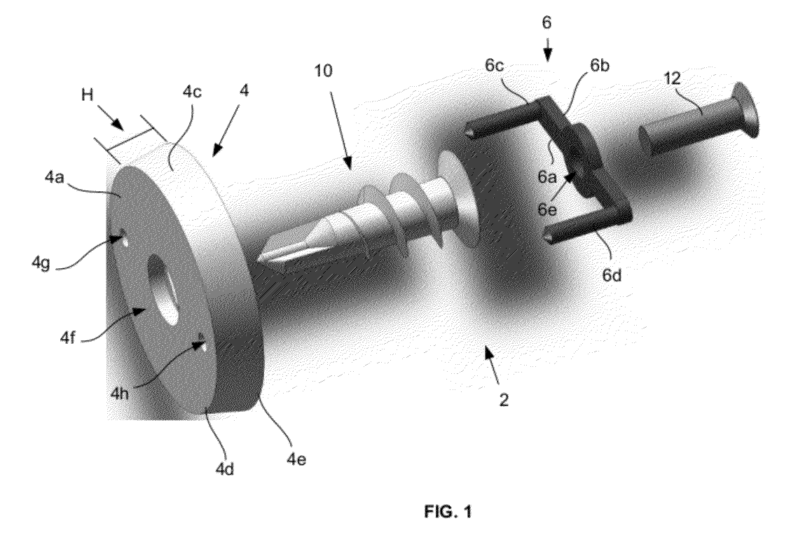

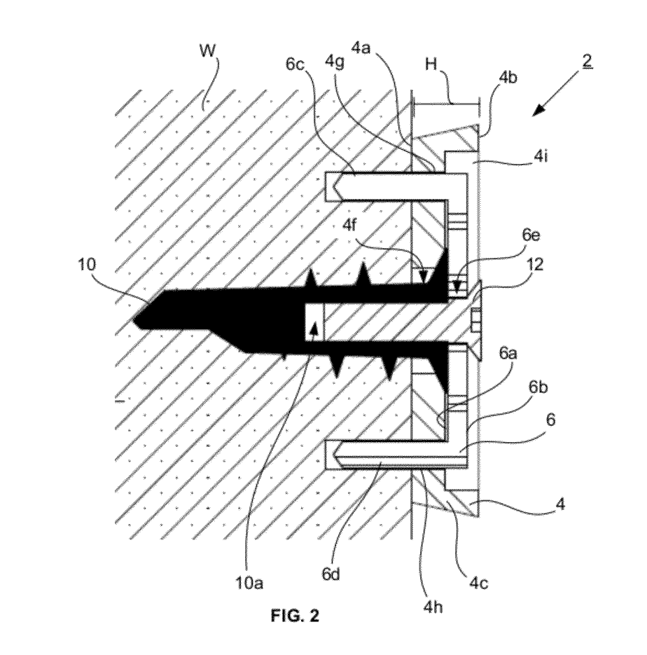

As noted, the current disclosure is directed to a variety of mounting systems for mounting to drywall to provide an interface with an accessory. FIG. 1 illustrates a perspective view of mounting system 2, which represents a first embodiment of a mounting system as disclosed herein. FIG. 2 illustrates a cut-away view of mounting system 2 interfaced with drywall W. System 2 is also configured for interfacing with an accessory, which will be discussed in more detail below.

Referring to both FIGS. 1 and 2, system 2 includes an accessory adapter plate (AAP) 4, a fixation plate (FP) 6, a drywall fastener 10, and a second fastener 12. Briefly, in terms of operation, drywall fastener 10 is used to secure AAP 4 to the wall. FP 6 is then secured to AAP 4 with second fastener 12 to prevent the rotation of the AAP. Accessories can then be quickly and securely attached to the AAP.

In the majority of examples, AAPs will be non-directional, meaning it can be installed without concern for a top or bottom, etc. In the example shown, AAP 4 is circular and non-directional, but other shapes may be used for a non-directional configuration, e.g. squares or other regular polygons.

AAP 4 includes a wall-side (WS) 4a for abutting wall W. AAP's WS 4a may be substantially planner, thereby allowing AAP 4 to flushly abut wall W. In other examples, wall-sides may have other surfaces or textures to accommodate the surfaces of other walls. Opposite WS 4a is accessory-side (AS) 4b for positioning proximal to the accessory. In between the WS and the AS, the AAP defines a perimeter wall (PW) 4c having a height (H). Height H may vary from example to example, e.g., from 3 mm to 20 mm. In many examples, H will be from about 4 mm to about 7 mm. Other examples, include other sizes.

AAP 4 includes a WS perimeter 4d defined by WS and an AS perimeter 4e defined by the AS. In this example, the AS perimeter is a greater length than the WS perimeter, but in other examples, the AS perimeter and WS perimeter can be of different lengths, e.g., the AS perimeter and WS perimeter can be the same length.

AAP 4 defines stabilization apertures 4g and 4h, which are examples of an AAP having at least one stabilization aperture (SA). Some examples include a single SA, and some examples include a 3, 4 ,5 or more SA. SA positioning may vary from example to example, for example, SAs may be positioned radially in the APP.

As seen, in this example fastener 10 is a distinct drywall fastener, and AAP 4 defines a mounting aperture (MA1) 4f for receiving drywall fastener 10. Further, drywall fastener 10 defines an aperture 10a for receiving the second fastener 12. In this example, MA1 is centrally located in said AAP, but in other examples, MA1s can be located in other places.

System 2 also includes a fixation plate 6, which is one example of a fixation plate (FP) as used herein. Fixation plate 6 includes a first side 6a for positioning proximal to the AAP, and a second side 6b for positioning proximal to the accessory.

FP 6 also includes at least one projection, e.g., 6c or 6d, which may extend from the first side. FP projections are typically configured to align with SA of the AAP when the FP is secured to the AAP. In the example shown, for example, projection 6c extends through SA 4g and projection 6d extends through projection 4h. Projections will commonly have a length sufficient to extend through the AAP and penetrate the wall. For example, projections may penetrate at least 0.5 cm into the wall. In other examples, projections may penetrate to other depths.

In some examples, as illustrated, AAP will define a recessed channel, e.g., 4i, for receiving the FP. The shape of the recessed channel may vary from embodiment to embodiment.

FP 6 includes mounting aperture 6e. In this example, mounting aperture 6e is configured to overlap aperture 10a of the dry wall fastener, thereby allowing second fastener 12 to secure FP 6 the AAP 4.

Using system 2, AAP 4 can be attached to wall W quickly in the desired location using drywall fastener 10, e.g., by rotating fastener 10 using a screw driver. FP 6 can then be positioned relative to AAP 4 such that projections 6c and 6d of FP 6 align with SA 4g and SA 4h, and, such that mounting aperture 6e aligns with aperture 10a of the drywall fastener. Second fastener 12 is then inserted through mounting aperture 6e and into aperture 10a, where it is secured, for example, by rotation. The tightening of fastener 12 may serve to force projections 6c and 6d into the drywall. Projections may also be driven into the drywall prior to rotation of the fastener.

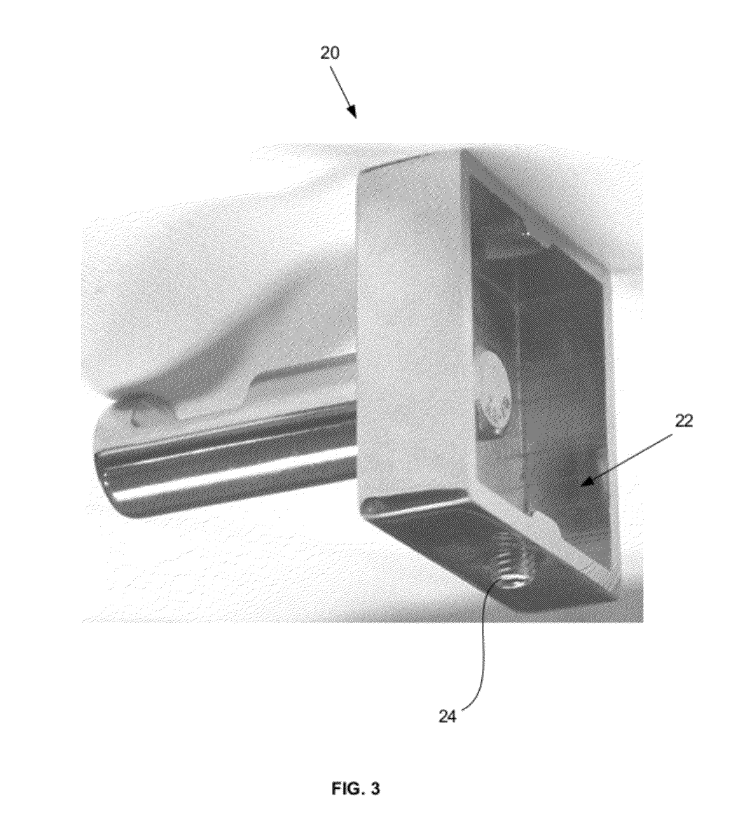

Once system 2 is secured to the wall, for example as seen in FIG. 2, any of a variety of accessories may be attached to the AAP. FIG. 3 illustrates accessory 20, which is one example of an accessory capable of attaching to mounting systems disclosed herein. In this example, accessory 20 is a hook, e.g., for hand towels, utensils, etc. Accessories include a cavity, e.g. cavity 22, for receiving the AAP of the mounting system. Accessories may also include a securing means, e.g. set screw 24, for securing the accessory to the AAP once the accessory cavity has received the AAP. Further, accessories may attach to AAPs in a manner that reduces an accessory's tendency to rotate. For example, an AAP's PW may defines at least one groove running from the WS to the AS, which increases the purchase of the securing means 24 and reduces rotational movement of the accessory relative to said AAP. In other examples, grooves may be located in other ways. Further, in some examples, groves or flanges may be included to reduce an accessories tendency from being pulled off the AAP un-intentionally.

It should be clear that a plurality of mounting systems may be used to interface with an accessory. For example, larger accessories, e.g., mirrors, shelves, hand rails, etc., may include a plurality of cavities for receiving any number of AAPs.

Another benefit of many examples of the mounting system, e.g. those including a centrally located MA1, is that they allow the mounting system to be attached to the wall centered at the point where accessory is to be positioned or attached, for example, without needing to calculate for a suspension distance created by many traditional mounting hooks and plates.

In addition to the above benefits, many mounting systems will provide an exceptionally strong interface to the drywall, without requiring additional support structures, e.g., drywall toggle bolts or other devices located behind the drywall. Further, mounting systems disclosed herein can be readily removed from the drywall with minimal damage to wall surface or structural integrity.

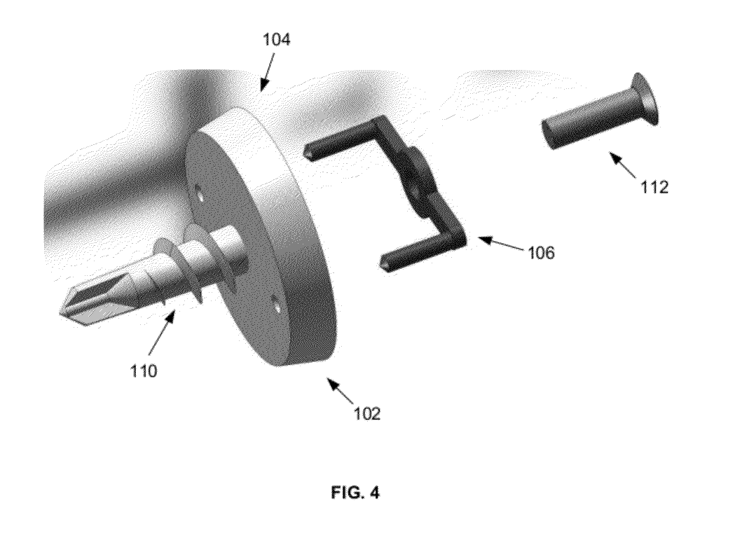

FIG. 4 illustrates mounting system 102, which represents a second embodiment of a mounting system disclosed herein. The second embodiment, similar to the first embodiment, includes an AAP 104, an FP 106, a drywall fastener 110, and a second fastener 112. The second embodiment differs from the first embodiment in that drywall fastener 110 is connected to AAP 110. Using second embodiment examples, the AAP can be fastened to the drywall simply by rotating the AAP by hand. The AAP may also be fastened using a tool, e.g. pliers, for example. Other parts may be similar to any of those described for the first embodiment.

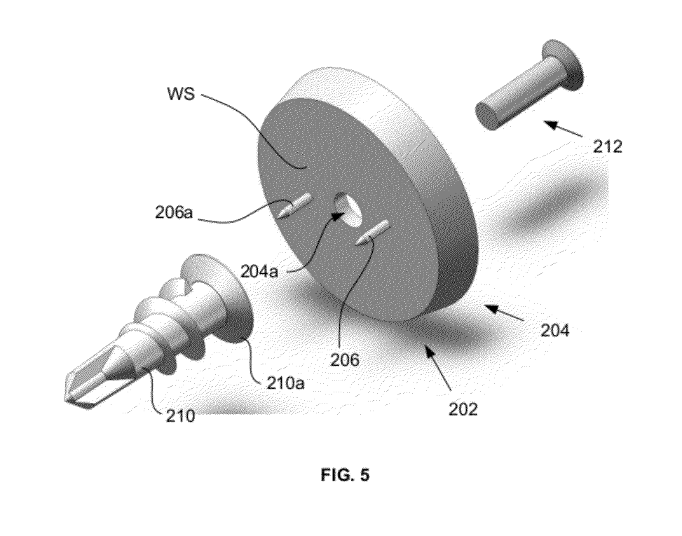

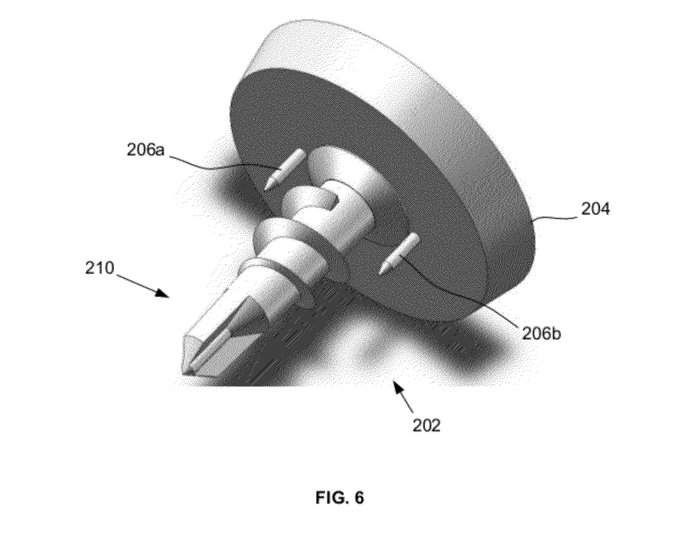

FIGS. 5 and 6 illustrate mounting system 202, which represents a third embodiment of a mounting system disclosed herein. The third embodiment, similar to the previous embodiments, includes an AAP 204, a drywall fastener 210, and a secondary fastener 212 (not visible in FIG. 6). Drywall fastener 210 includes a channel for receiving the secondary fastener as previously discussed. The third embodiment differs from the previous two embodiments in that it does not include a FP. Further, the AAP includes at least one projection, e.g., 206a and 206b.

In terms of operation, drywall fastener 210 is inserted in the desired location. AAP 204 is then positioned over drywall fastener 210 such that mounting aperture 204a aligns with the channel for receiving the secondary fastener. The secondary fastener is then used to secure AAP 204 to the drywall fastener. In this example, the drywall fastener, e.g., head 210a, is configured to abut the WS of the AAP. Head 210a will typically be flat on its surface and larger than the opening size of the mounting aperture 204a.

Other parts of the mounting system may be similar to those described in the previous embodiments.

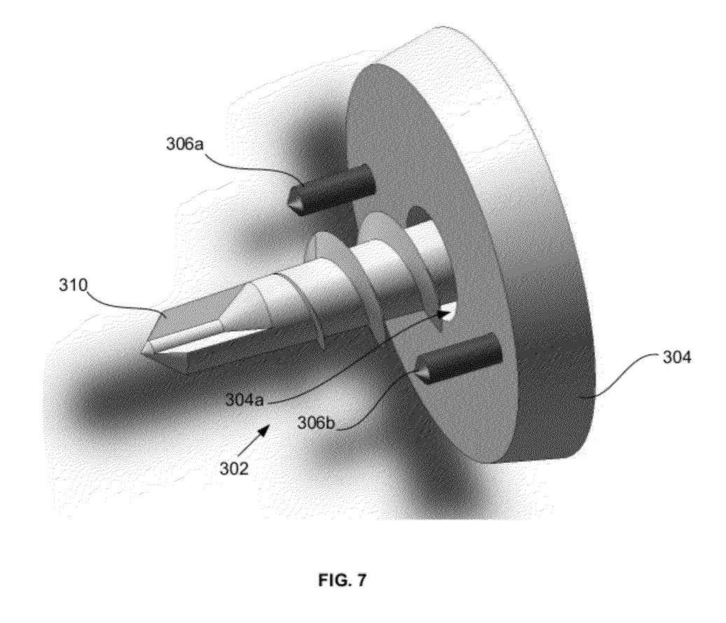

FIG. 7 illustrates mounting system 302, which represents a fourth embodiment of a mounting system as disclosed herein. The fourth embodiment, similar to previous embodiments includes AAP 304, and a discrete drywall fastener 310. Similar to the third embodiment, AAP 304 defines at least one projection, e.g. 306a and 306b, and does not include a FP. In this embodiment, AAP 304 includes a mounting aperture MA1 304a, and drywall fastener 310 is configured to be received by MA1 and secure AAP 304 to the wall by penetration.

Numerous characteristics and advantages have been set forth in the foregoing description, together with details of structure and function. Using the disclosure contained herein, a variety of accessories can be readily attached to walls. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1. An mounting system for interfacing with a wall and an accessory, said system comprising:
an accessory adapter plate (AAP) having
a wall-side (WS) for abutting the wall,
an accessory-side (AS) for positioning proximal to the accessory, and
a perimeter wall (PW) having a height (H), a WS perimeter and a AS perimeter,
wherein said AAP defines at least one stabilization aperture (SA);
a fixation plate (FP) having
a first side for positioning proximal to said AAP,
a second side for positioning proximal to the accessory, and
at least one projection extending from said first side,
wherein said FP defines a FP mounting aperture;
a drywall fastener configured to secure said AAP to the wall, and
a second fastener configured to secure said FP to said AAP.

2. The system of claim 1, wherein said WS of said AAP is substantially planner, thereby allowing said AAP to flushly abut the wall.

3. The system of claim 1, wherein said AS of said AAP defines a recessed channel encompassing said SA.

4. The system of claim 3, wherein said recessed channel has a shape and depth for receiving said fixation plate.

5. The system of claim 1, wherein said AS perimeter is greater than or equal to said WS perimeter.

6. The system of claim 1, wherein said AS perimeter is greater than said WS perimeter.

7. The system of claim 1, wherein the H of said PW is from 3 mm to 20 mm.

8. The system of claim 1, wherein said PW defines at least one groove for facilitating interface with the accessory.

9. The system of claim 8, wherein said at least one groove is oriented to reduce rotational movement of the accessory relative to said AAP.

10. The system of claim 1, wherein said FP's at least one projection is configured to align with said AAP's SA when said FP is secured to said AAP.

11. The system of claim 10, wherein said FP's at least one projection has a length sufficient to extend through said AAP and penetrate the wall.

12. The system of claim 1, wherein said SA is radially located in said AAP.

13. The system of claim 1, wherein said AAP is non-directional, whereby it can be interfaced with the accessory regardless of its rotational orientation relative to the wall.

14. The system of claim 13, wherein said AAP is circular.

15. The system of claim 1, wherein said drywall fastener is a distinct fastener, and wherein said AAP defines a mounting aperture (MA1) for receiving said drywall fastener.

16. The system of claim 15, wherein said MA1 is centrally located in said AAP.

17. The system of claim 16, wherein said FP mounting aperture is configured to overlap said dry wall fastener.

18. The system of claim 17, wherein said drywall fastener defines an aperture for receiving said second fastener.

19. The system of claim 1, wherein said drywall fastener is connected to said AAP.

20. An mounting system for interfacing with a wall and an accessory, said system comprising:
an accessory adapter plate (AAP) having
a wall-side (WS) for abutting the wall,
an accessory-side (AS) for positioning proximal to the accessory, and
a perimeter wall (PW) having a height (H), a WS perimeter and a AS perimeter,
wherein said AAP defines at least one projection extending from said WS, and
wherein said AAP defines a mounting aperture (MA1) for receiving a fastener; and
a drywall fastener.

21. The system of claim 20, wherein said drywall fastener is configured to be received by said MA1 and secure said AAP to the wall by penetration.

22. The system of claim 20, further including a second fastener, wherein said drywall fastener defines an aperture for receiving said second fastener, and wherein said drywall fastener is configured to abut the WS of the AAP.

23. The system of claim 20, wherein said WS of said AAP is substantially planner adjacent to said at least one projection extending from said WS, thereby allowing said AAP to flushly abut the wall when said at least one projection is inserted into the wall.

24. The system of claim 20, wherein said MA1 is centrally located in said AAP and said at least one projection is radially located in on said AAP.

25. The system of claim 20, wherein said AAP is non-directional, whereby it can be interfaced with the accessory regardless of its rotational orientation relative to the wall.
